(19) United States
(12) Patent Application Publication
(10) Pub. No.: US 2017/0097036 A1
(43) Pub. Date: Apr. 6, 2017

(54) TELESCOPING ASSEMBLY

(71) Applicant: Graham-White Manufacturing Company, Salem, VA (US)

(72) Inventors: Don Miehe, Salem, VA (US); Mark Taylor, Salem, VA (US); Don Hughes, Salem, VA (US); Jonathan McGlumphy, Salem, VA (US)

(21) Appl. No.: 14/873,254

(22) Filed: Oct. 2, 2015

(51) Int. Cl. F16C 3/03; F16B 7/10

(52) U.S. Cl. CPC F16C 3/03; F16B 7/105

(57) ABSTRACT

A telescoping assembly includes a rod with a recess in the rod. A first collar surrounds the rod, and a detent extends through the first collar. A second collar surrounds at least a portion of the first collar. The second collar has a locked position biasing the detent radially inward through the first collar and against the recess in the rod and an unlocked position allowing the detent to move radially outward through the first collar and away from the rod.

### FIELD OF THE INVENTION

The present invention generally involves a telescoping assembly that may be connected to a tool to facilitate remotely positioning the tool.

### BACKGROUND OF THE INVENTION

Many assemblies exist for telescopically extending and retracting a tool to reach targets at varying distances. For example, numerous telescoping assemblies exist to extend a tool to reach a light bulb, remove the light bulb, and reinstall a new light bulb.

In industrial applications, the telescoping assembly often needs to be considerably more robust to enable the tool to function while also ensuring adequate safety. For example, industrial applications often require larger and heavier tools capable of extending greater distances and imparting larger forces at varying angles to the target. In addition, weather conditions, topography, and operator skill and training may vary considerably in industrial applications. As a result, the need exists for an improved telescoping assembly that can accommodate additional weight, distance, and/or force needs without compromising safety, reliability, ease of use, and/or durability.

### BRIEF DESCRIPTION OF THE INVENTION

Aspects and advantages of the invention are set forth below in the following description, or may be obvious from the description, or may be learned through practice of the invention.

One embodiment of the present invention is a telescoping assembly that includes a rod with a recess in the rod. A first collar surrounds the rod, and a detent extends through the first collar. A second collar surrounds at least a portion of the first collar. The second collar has a locked position biasing the detent radially inward through the first collar and against the recess in the rod and an unlocked position allowing the detent to move radially outward through the first collar and away from the rod.

In another embodiment, a telescoping assembly includes a rod with a recess in the rod. A rod casing surrounds at least a portion of the rod and is in sliding engagement with the rod. A first collar surrounds the rod, and a detent extends through the first collar. A second collar surrounds at least a portion of the first collar, and the second collar has a first inner diameter and a second inner diameter. The second collar has a locked position in which the first inner diameter forces the detent radially inward through the first collar and against the recess in the rod and an unlocked position in which the second inner diameter allows the detent to move radially outward through the first collar and away from the rod.

In yet another embodiment, a telescoping assembly includes a rod with a recess in the rod. A rod casing surrounds at least a portion of the rod and is in sliding engagement with the rod. A releasable lock between the rod and the rod casing has a releasable lock comprising a first collar that surrounds the rod and a detent that extends through the first collar. The releasable lock has a locked position biasing the detent radially inward through the first collar and against the recess in the rod and an unlocked position allowing the detent to move radially outward through the first collar and away from the rod.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a telescoping assembly according to one embodiment of the present invention in an extended position;

FIG. 2 is a perspective view of the telescoping assembly shown in FIG. 1 in a retracted position;

FIG. 3 is a perspective partial cross-section view of a first collar or retainer according to one embodiment of the present invention;

FIG. 4 is a perspective partial cross-section view of a second collar according to one embodiment of the present invention;

FIG. 5 is an axial cross-section view of the telescoping assembly shown in FIGS. 1 and 2 taken along line A-A in a locked position;

FIG. 6 is an axial cross-section view of the telescoping assembly shown in FIGS. 1 and 2 taken along line A-A in an unlocked position;

FIG. 7 is a radial cross-section view of the telescoping assembly shown in FIGS. 1 and 2 taken along line B-B; and

FIG. 8 is a perspective view of a distal portion of the telescoping assembly shown in FIGS. 1 and 2.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

Each example is provided by way of explanation of the invention, not limitation of the invention. In fact, it will be apparent to those skilled in the art that modifications and variations can be made to embodiments of the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a telescoping assembly that may be connected to a tool to securely extend and retract the tool, locking the tool at various lengths. In particular embodiments, the telescoping assembly may also prevent the tool from rotating with respect to the assembly. Alternately, or in addition, one or more bushings or dampers in the telescoping assembly may resist extension or retraction to reduce inadvertent movement of the tool with respect to the assembly. Various combinations of these and other features thus enable the telescoping assembly to accommodate additional weight, distance, and/or force needs without compromising safety, reliability, ease of use, and/or durability.

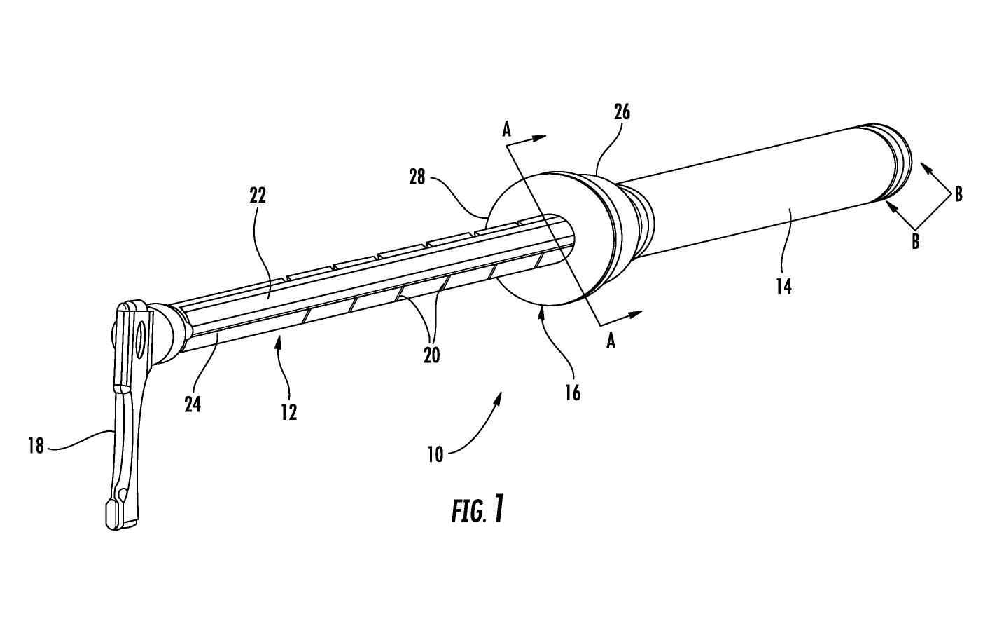

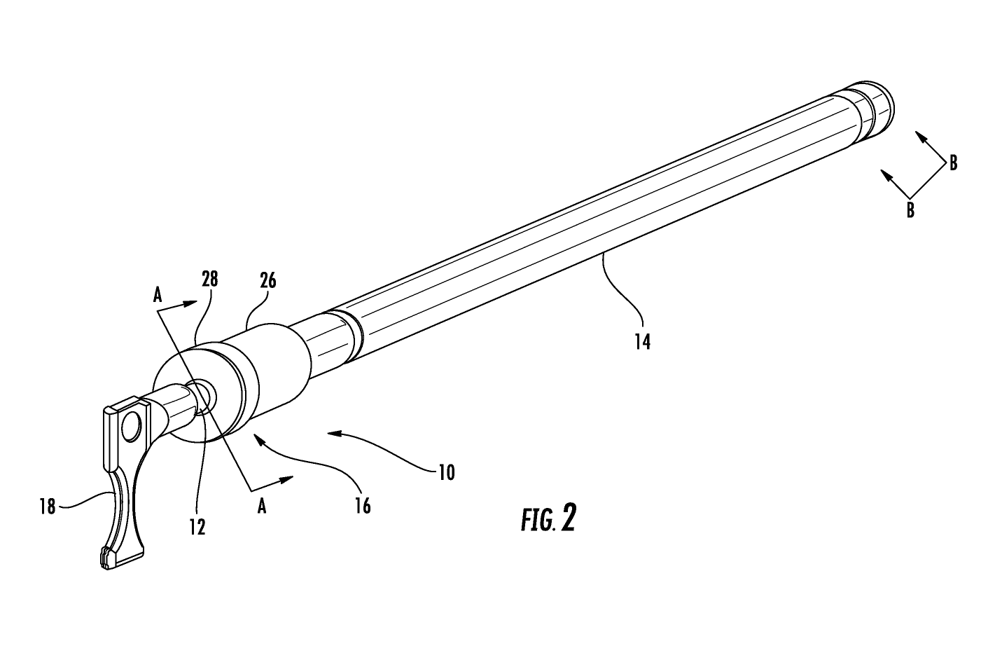

FIGS. 1 and 2 provide a perspective view of a telescoping assembly 10 according to one embodiment of the present invention in extended and retracted positions, respectively. As shown in FIGS. 1 and 2, the telescoping assembly 10 may include a rod 12, a rod casing 14 in sliding engagement with the rod 12, and a releasable lock 16 between the rod 12 and the rod casing 14.

The rod 12 connects to a tool 18 and may be constructed from wood, fiberglass, aluminum, hardened steel, or any material suited for the anticipated environmental and force demands of the tool 18. The rod 12 may include one or more recesses 20, grooves, ridges, notches, or similar surface features that enhance engagement between rod 12 and the releasable lock 16 to securely hold the rod 12 at various positions with respect to the rod casing 14. In particular embodiments, the rod 12 may include one or more angled surfaces 22 that engage with complementary surfaces inside the rod casing 14 or releasable lock 16 to prevent the rod 12 from rotating with respect to the rod casing 14 and/or releasable lock 16. The rod 12 may further include rounded vertices 24 joining adjacent angled surfaces 22 to reduce or eliminate sharp edges in the rod 12. The recesses 20 and angled surfaces 22, if present, enhance safety of the telescoping assembly 10 by minimizing or preventing inadvertent movement of the tool 18 with respect to the rod casing 14.

The rod casing 14 may surround at least a portion of the rod 12 to allow the rod 12 to alternately slide into and out of the rod casing 14. In this manner, the rod casing 14 may protect the rod 12 while also providing a convenient handle and extension for the rod 12 and tool 18. As with the rod 12, the rod casing 14 may be constructed from wood, fiberglass, aluminum, hardened steel, or any material suited for the anticipated environmental and force demands of the tool 18.

The releasable lock 16 controls relative movement between the rod 12 and the rod casing 14. Externally, the releasable lock 16 may include a sleeve or casing 26 adjacent to an operator 28. The sleeve or casing 26 protects the internal components of the releasable lock 16. Manipulation of the operator 28 with respect to the sleeve 26 repositions the releasable lock 16 between a locked position and an unlocked position. The locked position prevents movement of the rod 12 with respect to the rod casing 14, and the unlocked position permits movement of the rod 12 with respect to the rod casing 14. Internally, the releasable lock 16 may include a first collar or retainer 30, a second collar 32, and one or more detents 34.

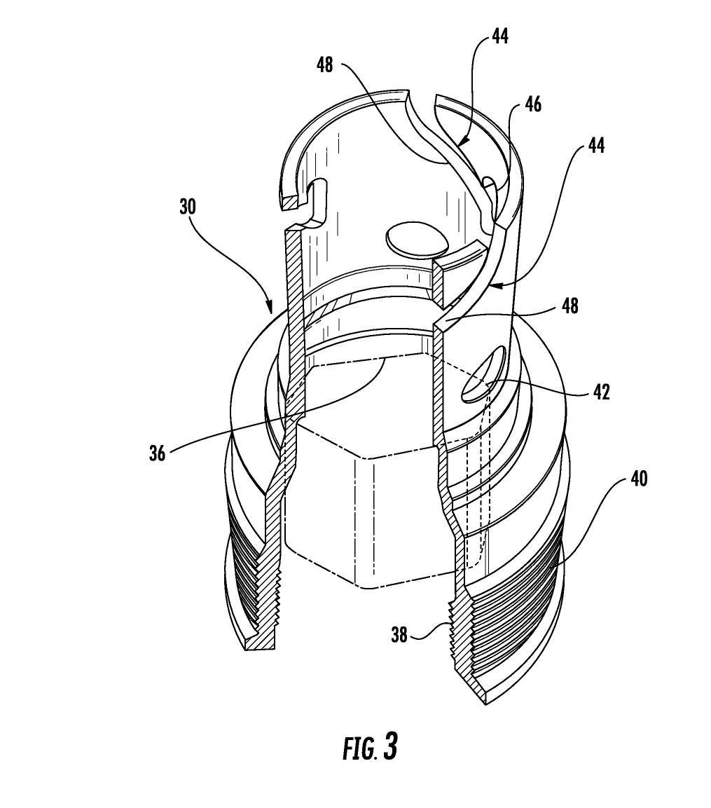

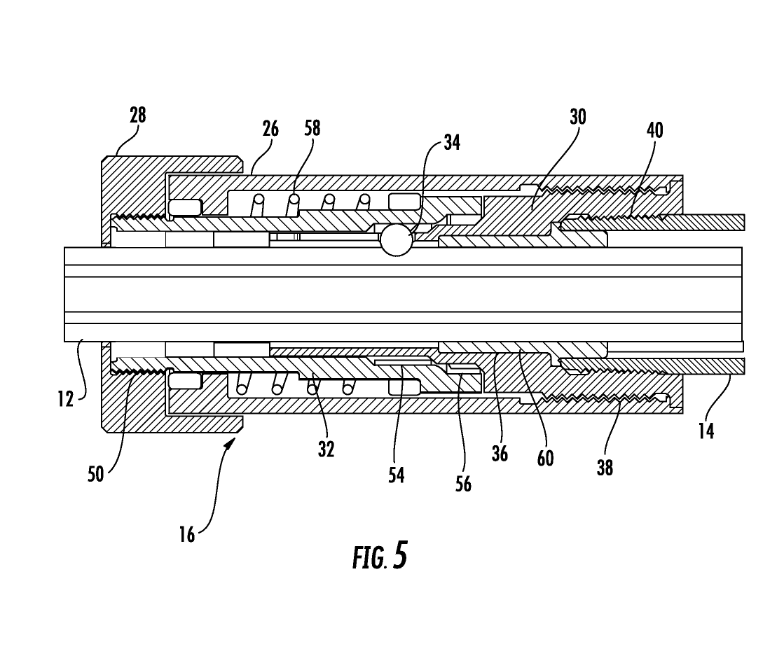

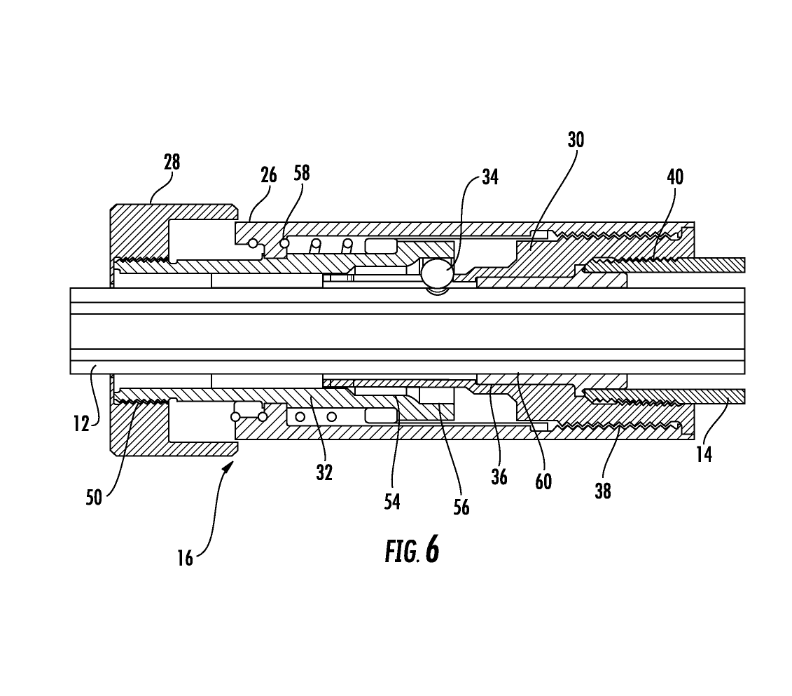

FIG. 3 provides a perspective partial cross-section view of the first collar or retainer 30 according to one embodiment of the present invention. The first collar 30 is generally cylindrical to surround the rod 12 while also conforming to the inside of the sleeve or casing 26 of the releasable lock 16. In this particular embodiment, the first collar 30 includes one or more angled surfaces 36 that engage with complementary angled surfaces 22 on the rod 12 to rotationally couple the rod 12 to the first collar 30. The first collar 30 also includes internal threads 38 and external threads 40 for attaching the first collar 30 to complementary threads on the rod casing 14 and sleeve 26, as will be discussed with respect to FIGS. 5 and 6.

As shown in FIG. 3, the first collar 30 may also include one or more apertures 42 and slots 44. The apertures 42 extend through the first collar 30 to allow the one or more detents 34, such as bearing balls, to move radially inside each aperture 42 during operation of the releasable lock 16. Each slot 44 may include an axial portion 46 extending axially along the first collar 30 and a circumferential portion 48 extending circumferentially around the first collar 30.

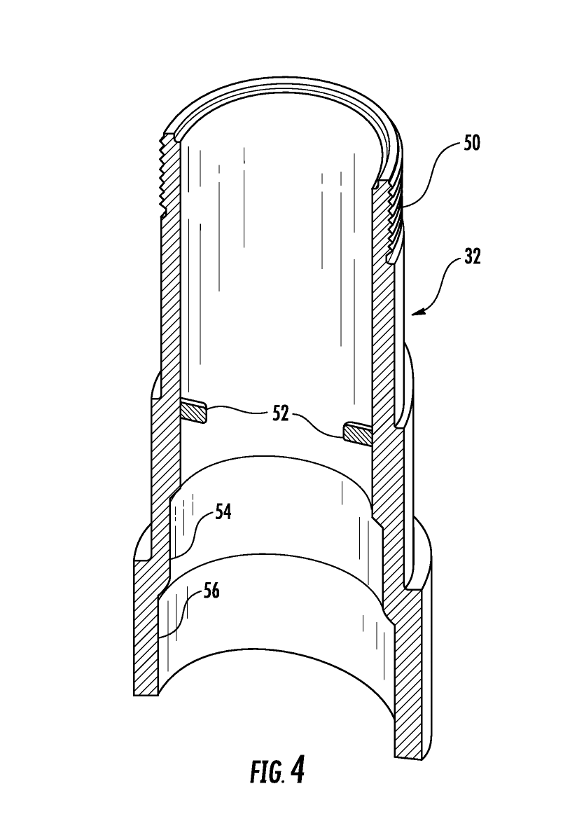

FIG. 4 provides a perspective partial cross-section view of the second collar 32 according to one embodiment of the present invention. The second collar 32 is again generally cylindrical to surround at least a portion of the first collar 30. External threads 50 engage with complementary threads on the operator 28, as will be discussed with respect to FIGS. 5 and 6. The second collar 32 also includes a varying internal diameter that surrounds a portion of the first collar 30 and one or more tabs 52 that extend radially inward from the second collar 32. Specifically, the second collar 32 defines a first internal diameter 54 and a larger second internal diameter 56. The first internal diameter 54 axially aligns with the apertures 42 in the first collar 30 when the releasable lock 16 is in the locked position, and the larger second internal diameter 56 axially aligns with the apertures 42 in the first collar 30 when the releasable lock is in the unlocked position. The tabs 52 ride inside the slots 44 in the first collar 30 to guide axial and circumferential movement of the second collar 32 with respect to the first collar 30 during operation of the releasable lock 16.

FIGS. 5 and 6 provide axial cross-section views of the telescoping assembly 10 shown in FIGS. 1 and 2 taken along line A-A in locked and unlocked positions, respectively. The locked position (FIG. 5) prevents movement of the rod 12 with respect to the rod casing 14, and the unlocked position (FIG. 6) permits movement of the rod 12 with respect to the rod casing 14.

In the particular embodiment shown in FIGS. 5 and 6, the first collar 30 is rotationally coupled to the rod casing 14 and the sleeve 26 of the releasable lock 16. For example, the internal threads 40 of the first collar 30 may be fixedly connected to complementary threads on the outside of the rod casing 14, and the external threads 38 of the first collar 30 may be fixedly connected to complementary threads on the inside of the sleeve 26. In this manner, the first collar 30 is rotationally coupled to both the rod casing 14 and the sleeve 26. The second collar 32 is similarly rotationally coupled to the operator 28. For example, the external threads 50 of the second collar 32 may be fixedly connected to complementary threads on the inside of the operator 28 so that the second collar 32 is rotationally coupled to the operator 28. A spring 58 inside the sleeve 26 and surrounding the second collar 32 biases the second collar to the right in FIGS. 5 and 6 toward the first collar 30.

In the absence of any force being applied to the operator 28, the releasable lock 16 will automatically shift to the locked position shown in FIG. 5 once the one or more recesses 20 in the rod 12 are axially aligned with the one or more detents 34. Specifically, as the spring 58 biases the second collar 32 to the right toward the first collar 30, the tabs 52 in the second collar 32 ride inside the slots 44 in the first collar 30 to rotate the second collar 32 and move the second collar 32 axially toward the first collar 30. If the one or more recesses 20 in the rod 12 are not axially aligned with the one or more detents 34, then the rod 12 will prevent the one or more detents 34 from moving radially inward through the apertures 42 in the first collar 30. As a result, the one or more detents 34 will engage with the smaller first internal diameter 54 of the second collar 32 to prevent further axial movement of the second collar 32 toward the first collar 30. As the rod 12 is extended or retracted from the rod casing 14, the one or more recesses 20 in the rod 12 will become axially aligned with the one or more detents 34. When the one or more recesses 20 in the rod 12 are axially aligned with the one or more detents 34, the spring 58 will force the smaller first internal diameter 54 of the second collar 32 to the right over the one or more detents 34, biasing the one or more detents 34 radially inward through the apertures 42 in the first collar 30 to engage with the one or more recesses 20 in the rod 12. The second collar 32 will move axially toward the first collar 30 until the tabs 52 reach the bottom of the axial portion 46 of the slots 44. In this locked position, the smaller first internal diameter 54 of the second collar 32 maintains the one or more detents 34 engaged against the one or more recesses 20 in the rod 12 and prevents the one or more detents 34 from moving radially outward. As a result, the second collar 32 and the releasable lock 16 are in the locked position with the one or more detents 34 engaged against the one or more recesses 20 to prevent the rod 12 from extending or retracting with respect to the rod casing 14.

The releasable lock 16 may be repositioned to the unlocked position shown in FIG. 6 to extend or retract the rod 12 with respect to the rod casing 14. To reposition the releasable lock 16 to the unlocked position, the operator 28 is manually operated to overcome the bias provided by the spring 58 to allow the second collar 32 to be moved axially away from the first collar 30, to the left in FIG. 6. Specifically, the operator 28 is slightly pulled away from and then rotated with respect to the sleeve 26 or rod casing 14. Since the second collar 32 is rotationally coupled to the operator 28, this sequential movement of the operator 28 causes the tabs 52 in the second collar 32 to first ride axially in the axial portion 46 of the slots 44 and then circumferentially in the circumferential portion 48 of the slots 44. The resulting movement of the second collar 32 axially away from the first collar 30 (to the left in FIG. 6) aligns the larger second internal diameter 56 of the second collar 32 with the one or more detents 34, allowing the one or more detents 34 to move radially outward through the apertures 42 in the first collar 30. As a result, the one or more detents 34 no longer engage with the one or more recesses 20 in the rod 12, and the rod 12 may be extended or retracted with respect to the rod casing 14. Once the operator 28 is released, the spring 58 biases the second collar 32 axially toward the first collar 30, and the releasable lock 16 automatically returns to the locked position, as previously described with respect to FIG. 5.

The particular design of the telescoping assembly 10 ensures that the releasable lock 16 automatically returns to and remains in the locked position unless and until the operator 28 is manually manipulated in the required sequence to unlock the releasable lock 16. Specifically, if the operator 28 is inadvertently bumped or pulled away from the sleeve 26 or rod casing 14, the tabs 52 of the second collar 32 will only slide in the axial portion 46 of the slots 44 in the first collar 30. The axial portion 46 of the slots 44 prevents the tabs 52, and thus the second collar 32, from moving axially away from the first collar 30 a sufficient distance to align the larger second internal diameter 56 of the second collar 32 with the one or more detents 34. As a result, the smaller first internal diameter 54 of the second collar 32 remains aligned with the one or more detents 34 to maintain the one or more detents 34 engaged with the one or more recesses 20 in the rod 12, preventing the rod 12 from moving with respect to the releasable lock 16 or rod casing 14.

In particular embodiments, the telescoping assembly 10 may also include means for inhibiting the sliding engagement between the rod 12 and the rod casing 14. The function of the means is to inhibit the sliding engagement between the rod 12 and the rod casing 14 to prevent the rod 12 from freely moving axially with respect to the rod casing 14 when the releasable lock 16 is in the unlocked position. In particular embodiments, the function may preferentially inhibit the rod 12 from retracting into the rod casing 14 more than it inhibits the rod 12 from extending from the rod casing 14. The structure for inhibiting the sliding engagement between the rod 12 and the rod casing 14 may include one or more bushings engaged with the rod 12. The bushings may be constructed of resilient material that resists wear over the life of the telescoping assembly 10, such that motion is consistently resisted. For example, as shown in FIGS. 5 and 6, the structure may include a bushing 60 engaged between the first collar 30 and the rod 12 to inhibit axial movement of the rod 12 with respect to the first collar 30 and thus the rod casing 14. The bushing 60 may surround the rod 12 and include internal and external angled surfaces to mate with the angled surfaces 22 in the rod 12 and the angled surfaces 36 in the first collar 30 to prevent rotational movement between the rod 12 and the first collar 30. If desired, the internal surface of the bushing 60 may include surface features that inhibit the rod 12 from retracting into the rod casing 14 more than extending from the rod casing 14.

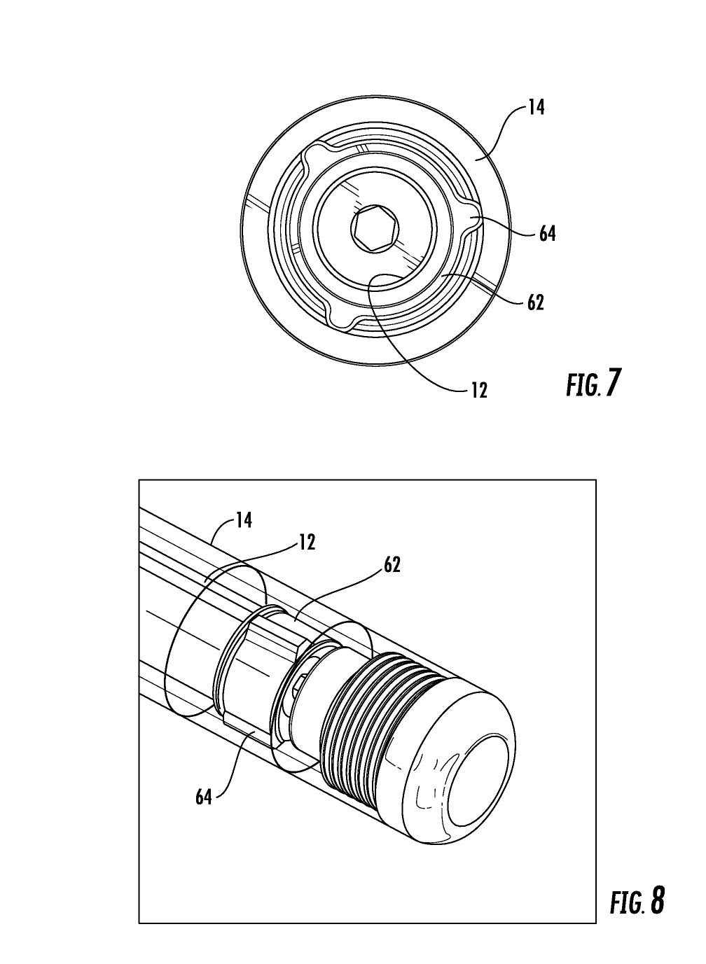

FIGS. 7 and 8 illustrate an alternate structure for inhibiting the sliding engagement between the rod 12 and the rod casing 14. FIG. 7 provides a radial cross-section view of the telescoping assembly 10 shown in FIGS. 1 and 2 taken along line B-B, and FIG. 8 provides a perspective view of a distal portion of the telescoping assembly 10 shown in FIGS. 1 and 2. As shown in FIGS. 7 and 8, the structure for inhibiting the sliding engagement between the rod 12 and the rod casing 14 may include a damper 62 engaged between the rod casing 14 and the rod 12 to inhibit axial movement of the rod 12 with respect to the rod casing 14. The damper 62 may be fixedly connected to the rod 12 with a friction fit inside the rod casing 14 to inhibit the sliding engagement between the rod 12 and the rod casing 14. In particular embodiments, the damper 62 may include external ribs 64 against the inside of the rod casing 14 that inhibit the rod 12 from retracting into the rod casing 14 more than extending from the rod casing 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A telescoping assembly, comprising:
a rod;
a recess in said rod;
a first collar that surrounds said rod;
a detent that extends through said first collar;
a second collar that surrounds at least a portion of said first collar; and
wherein said second collar has a locked position biasing said detent radially inward through said first collar and against said recess in said rod and an unlocked position allowing said detent to move radially outward through said first collar and away from said rod.

2. The telescoping assembly as in claim 1, wherein said rod and said first collar comprise a plurality of angled surfaces that engage with one another to rotationally couple said rod to said first collar.

3. The telescoping assembly as in claim 1, further comprising a slot in said first collar and a tab extending radially inward from said second collar into said slot.

4. The telescoping assembly as in claim 3, wherein said slot in said first collar comprises an axial portion extending axially along said first collar and a circumferential portion extending circumferentially around said first collar.

5. The telescoping assembly as in claim 1, wherein said second collar is biased toward said first collar.

6. The telescoping assembly as in claim 1, wherein said second collar defines a first internal diameter and a second internal diameter larger than said first internal diameter.

7. A telescoping assembly, comprising:
a rod;
a recess in said rod;
a rod casing surrounding at least a portion of said rod and in sliding engagement with said rod;
a first collar that surrounds said rod;
a detent that extends through said first collar;
a second collar that surrounds at least a portion of said first collar, said second collar having a first inner diameter and a second inner diameter; and
wherein said second collar has a locked position in which said first inner diameter forces said detent radially inward through said first collar and against said recess in said rod and an unlocked position in which said second inner diameter allows said detent to move radially outward through said first collar and away from said rod.

8. The telescoping assembly as in claim 7, wherein said rod and said first collar comprise a plurality of angled surfaces that engage with one another to rotationally couple said rod to said first collar.

9. The telescoping assembly as in claim 7, wherein said first collar is rotationally coupled to said rod casing.

10. The telescoping assembly as in claim 7, further comprising a slot in said first collar and a tab extending radially inward from said second collar into said slot.

11. The telescoping assembly as in claim 10, wherein said slot in said first collar comprises an axial portion extending axially along said first collar and a circumferential portion extending circumferentially around said first collar.

12. The telescoping assembly as in claim 7, wherein said second collar is biased toward said first collar.

13. The telescoping assembly as in claim 7, wherein said second collar defines a first internal diameter and a second internal diameter larger than said first internal diameter.

14. The telescoping assembly as in claim 7, further comprising means for inhibiting said sliding engagement between said rod and said rod casing.

15. A telescoping assembly, comprising:
a rod;
a recess in said rod;
a rod casing surrounding at least a portion of said rod and in sliding engagement with said rod;
a releasable lock between said rod and said rod casing, said releasable lock comprising a first collar that surrounds said rod and a detent that extends through said first collar; and
wherein said releasable lock has a locked position biasing said detent radially inward through said first collar and against said recess in said rod and an unlocked position allowing said detent to move radially outward through said first collar and away from said rod.

16. The telescoping assembly as in claim 15, wherein said rod and said first collar comprise a plurality of angled surfaces that engage with one another to rotationally couple said rod to said first collar.

17. The telescoping assembly as in claim 15, wherein said first collar is rotationally coupled to said rod casing.

18. The telescoping assembly as in claim 15, further comprising a slot in said first collar, a second collar that surrounds at least a portion of said first collar, and a tab extending radially inward from said second collar into said slot.

19. The telescoping assembly as in claim 18, wherein said second collar defines a first internal diameter and a second internal diameter larger than said first internal diameter.

20. The telescoping assembly as in claim 15, further comprising means for inhibiting said sliding engagement between said rod and said rod casing.
